(19) United States
(12) Patent Application Publication
(10) Pub. No.: US 2018/0124704 A1
(43) Pub. Date: May 3, 2018

(54) Method of Wake-up Signal Transmission and Reception

(71) Applicant: MEDIATEK INC., Hsin-Chu (TW)

(72) Inventors: Shih-Ching Jung, Hsinchu City (TW); Chee-Lee Heng, Singapore (SG); Shang-Wei Huang, Hsinchu County (TW); Shu-Liang Lee, Hsinchu City (TW); Yuan-Hung Chung, Hsinchu County (TW)

(21) Appl. No.: 15/342,125

(22) Filed: Nov. 3, 2016

(51) Int. Cl. H04W 52/02

(52) U.S. Cl. CPC H04W 52/0229; H04W 84/12

(57) ABSTRACT

A method of wake-up signal transmission for an access point (AP) in a wireless communication system is disclosed. The method comprises transmitting a beacon for notification of a Wi-Fi device in the wireless communication system, and transmitting a wake-up signal to the Wi-Fi device, wherein the wake-up signal is a binary signal for indicating the Wi-Fi device to receive or not to receive a data from the AP.

### BACKGROUND

Wi-Fi has become a very important feature in modern electronic devices, including smart phones, tablets, Internet of Things (IoT) devices, notebooks, PCs, etc. Wi-Fi can provide cheaper and faster internet experience than others. But for the long coverage and high throughput, Wi-Fi comes out more power consumption. For longer battery life, many low power mechanisms are provided for different user scenarios.

To save power consumption, typically Wi-Fi devices or stations (STAs) stay in Wi-Fi power saving mode (PSM), and have to wake up to receive beacon for every 102.4 ms by a target beacon transmission time (TBTT) timer, so that Wi-Fi devices/STAs will not miss data sent from the access point (AP). In addition, a delivery traffic indication map (DTIM) bit is set by the AP in the beacon to notify a specific Wi-Fi device/STA of buffered data. Therefore, the Wi-Fi device/STA turns the radio frequency (RF) component (e.g. receiver) on for receiving buffered data from the AP when the DTIM bit of the beacon is set to “1”, whereas the Wi-Fi device/STA does not turn the RF component on when the DTIM bit is set to “0”.

Refer to FIG. 1, which is a schematic diagram of power consumption of a power saving mode according to the prior art. In FIG. 1, the Wi-Fi device/STA enters a sleep mode when not receiving beacon, which only costs little power, say 200 uA in general. However, during a wake-up mode, the Wi-Fi device/STA turns on the RF component (e.g. receiver, amplifier, etc.), baseband/MAC, etc., which consumes a lot of power such as 70 mA in general, which elevates the average power consumption in Wi-Fi PSM to 1.5 mA.

In order to save more power, typical solutions focus on dynamically changing the interval of DTIM, such as increasing DTIM interval up to each 3, 4, or more beacon interval, instead of each one, to minimize average power consumption in Wi-Fi PSM. In detail, if DTIM interval is set to a large value, Wi-Fi device/STA may save more power since STA does not wake up so often. However, the typical solutions may have the following drawbacks:
1. The latency is increased;
2. The buffer-loading for AP is increased, and the packets may be dropped once buffer overflows;
3. Dynamically changing DTIM interval leads to more power consumption;
4. To catch DTIM in time, a basic sleep current (around 200 uA) is needed to boot up radio quickly.

### SUMMARY

It is therefore an objective to provide a method of wake-up signal transmission and reception, to save more power and extend battery life.

The present invention discloses a method of wake-up signal transmission for an access point (AP) in a wireless communication system. The method comprises transmitting a beacon for notification of a Wi-Fi device in the wireless communication system, and transmitting a wake-up signal to the Wi-Fi device, wherein the wake-up signal is a binary signal for indicating the Wi-Fi device to receive or not to receive a data from the AP.

The present invention further discloses a method of wake-up signal reception for a Wi-Fi device in a wireless communication system. The method comprises determining whether a received signal is a wake-up signal from an access point (AP) in the wireless communication system, to generate a determining result, wherein the wake-up signal is a binary signal for indicating the Wi-Fi device to receive or not to receive a data from the AP, and switching between an off mode and a sleep mode according to the determining result, wherein at least one parameter for receiving the data is stored in a non-volatile memory when the Wi-Fi device is in the off mode, and the at least one parameter for receiving the data is stored in a volatile memory when the Wi-Fi device is in the sleep mode.

The present invention further discloses an access point (AP) for wake-up signal transmission in a wireless communication system. The AP comprises a transmitter, for transmitting a beacon for notification of a Wi-Fi device in the wireless communication system and for transmitting a wake-up signal to the Wi-Fi device, and a signal generator, coupled to the transmitter, for generating the wake-up signal, wherein the wake-up signal is a binary signal for indicating the Wi-Fi device to receive or not to receive a data from the AP.

The present invention further discloses a Wi-Fi device for wake-up signal reception in a wireless communication system. The Wi-Fi device comprises an energy detecting module, for determining whether a signal received by a detector of the energy detecting module is a wake-up signal from an access point (AP), to generate a determining result, wherein the wake-up signal is a binary signal for indicating the Wi-Fi device to receive or not to receive a data from the AP, and a power manager, coupled to the energy detecting module, for switching the Wi-Fi device between an off mode and a sleep mode according to the determining result, wherein at least one parameter for receiving the data is stored in a non-volatile memory of the Wi-Fi device when the Wi-Fi device is in the off mode, and the at least one parameter for receiving the data is stored in a volatile memory of the Wi-Fi device when the Wi-Fi device is in the sleep mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of power consumption in a power saving mode according to the prior art.

FIG. 2 is a schematic diagram of an exemplary communication device.

FIG. 3 is a flowchart of an exemplary process according to the present disclosure.

FIG. 4 is a schematic diagram of a bit string corresponding to a wake-up signal according to the present disclosure.

FIG. 5 is a flowchart of an exemplary process according to the present disclosure.

FIG. 6 is a schematic diagram of power consumption in a power saving mode according to the present disclosure.

FIG. 7 is a schematic diagram of wake-up signal transmission and reception according to an example of the present disclosure.

FIG. 8A-8B are schematic diagrams of a two-level wake-up operation according to an example of the present disclosure.

FIG. 9 is a schematic diagram of structures of an access point and a Wi-Fi device according to an example of the present disclosure.

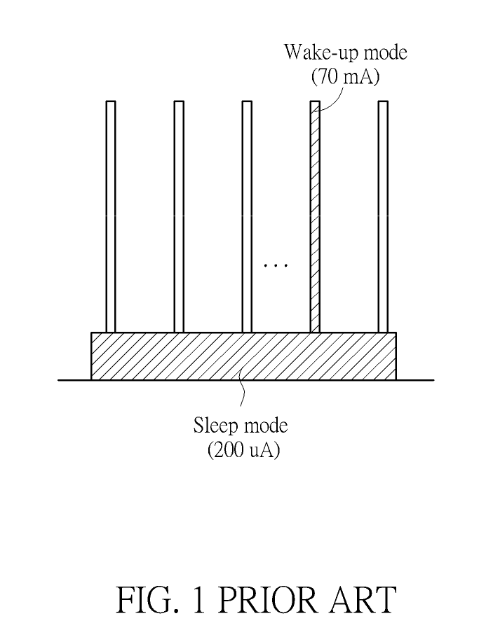

### DETAILED DESCRIPTION

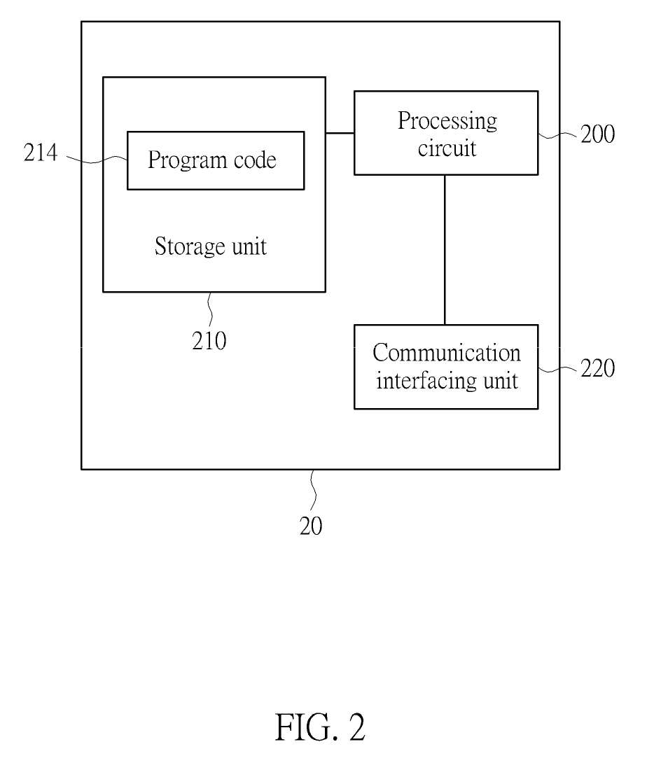

FIG. 2 illustrates a schematic diagram of an exemplary communication device 20. The communication device 20 can be a Wi-Fi device or an access point (AP). The Wi-Fi device can be devices such as wearable device, appliances, and machine type devices compatible to Wi-Fi specification. The communication device 20 may include a processing circuit 200 such as a microprocessor or Application Specific Integrated Circuit (ASIC), a storage unit 210 and a communication interfacing unit 220. The storage unit 210 may be any data storage device that can store program code 214, for access by the processing circuit 200. Examples of the storage unit 210 include but are not limited to a read-only memory (ROM), flash memory, random-access memory (RAM), CD-ROMs, magnetic tape, hard disk, and optical data storage device. The communication interfacing unit 220 is preferably a radio transceiver and can exchange wireless signals according to processing results of the processing circuit 200.

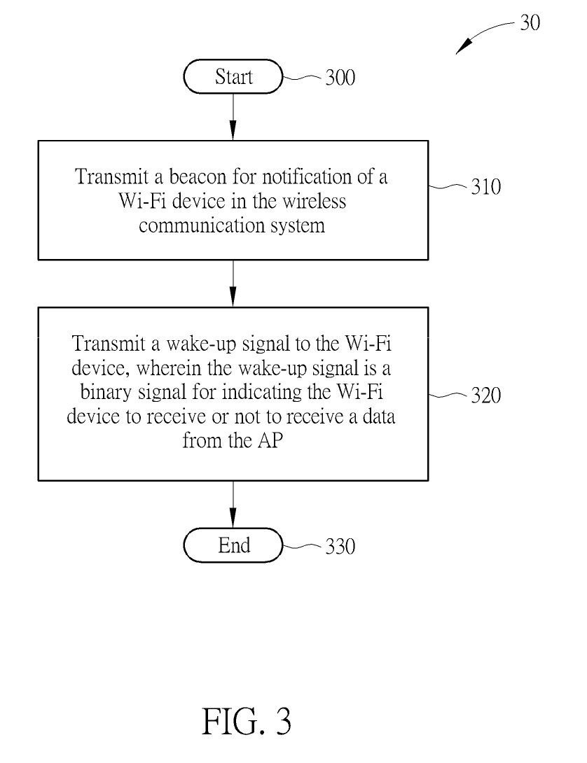

Please refer to FIG. 3, which is a flowchart of a process 30 according to an example of the present disclosure. The process 30 is utilized in the AP for wake-up signal transmission. The process 30 may be compiled into a program code 214 to be stored in the storage unit 210, and may include the following steps:

### Step 300: Start.

Step 310: Transmit a beacon for notification of a Wi-Fi device in the wireless communication system.
Step 320: Transmit a wake-up signal to the Wi-Fi device, wherein the wake-up signal is a binary signal for indicating the Wi-Fi device to receive or not to receive a data from the AP.

### Step 330: End.

According to the process 30, the AP wakes the Wi-Fi device up for data reception by a binary wake-up signal. In one embodiment, the wake-up signal represents a bit string including a plurality of bits each indicating which Wi-Fi device should wake up for receiving the data from the AP. In a word, the wake-up signal includes a bitmap for waking up Wi-Fi devices in a wireless environment.

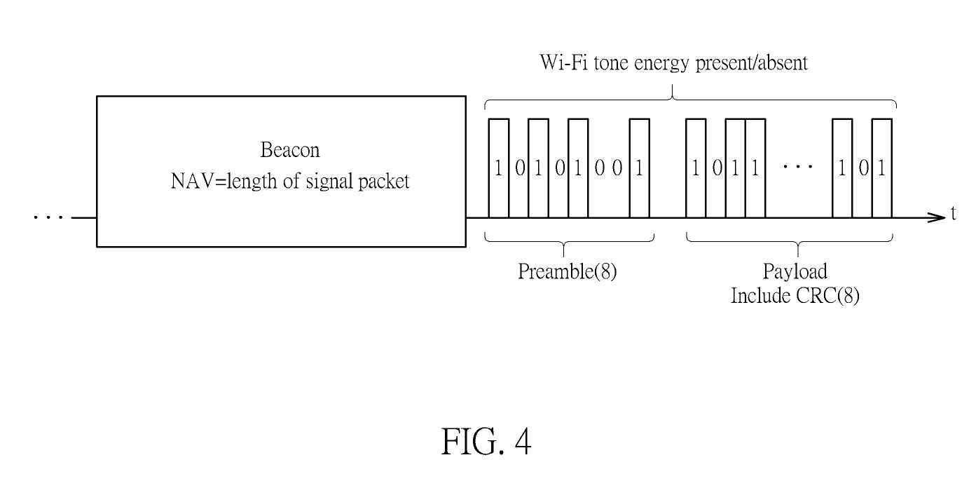

For generating of the wake-up signal, the AP may continuously transmits Wi-Fi signal (e.g. Wi-Fi tone) in MAC and/or baseband, and may utilize a switch to switch Wi-Fi signal output on/off, so as to create a bit string corresponding to the wake-up signal with Wi-Fi tone energy present/absent. Refer to FIG. 4, which is a schematic diagram of a bit string corresponding to a wake-up signal according to the present disclosure. In FIG. 4, the AP encodes a “1” bit with presence of Wi-Fi tone energy and a “0” bit with absence of Wi-Fi tone energy. In one embodiment, each Wi-Fi device may know which bit of the wake-up signal is corresponding to it. Therefore, a specific Wi-Fi device can check its corresponding bit of the bit string to know whether it should wake up or not. In another embodiment, the wake-up signal can be only sent to Wi-Fi device(s) that should wake up, so that only the Wi-Fi device receives the wake-up signal should wake up. In still another embodiment, the signal transmitted by the AP may not act only as the wake-up signal, but may also act as other kinds of signals. Then the bit string may include two parts, preamble and payload. The preamble may be used for indicating a message for a Wi-Fi device. The Wi-Fi device may need to check the payload to determine whether the message is a wake-up signal. If it is a wake-up signal, the Wi-Fi device knows to wake up or not according to the payload bit corresponding to it. For example, when the preamble bit and payload bit corresponding to the Wi-Fi device are set to “1”, the Wi-Fi device knows that there is a message for it and the message is a wake-up signal to wake it up for data reception. On the other hand, if the preamble bit is set to “1”, but the payload bit corresponding to the Wi-Fi device is set to “0”, the Wi-Fi device knows that there is a message for it and the message is not to wake up. If the preamble bit is set to “0”, the Wi-Fi device knows that no message for it.

In one embodiment, the AP may encode wake-up information (e.g. bit string) with a predefined pattern (e.g. preamble or payload pattern in 1010100101) or with a predefined number of bits within a predefined interval (e.g. 10 bits within the interval). Therefore, when the Wi-Fi device receives the bit string, it may know this is not interference but a wake-up signal. Moreover, in order to prevent interference (e.g. Wi-Fi packets) from other APs, the AP may assign network allocation vector (NAV) parameter in a beacon, for reserving the transmission channel to prevent packet contentions from other AP. Therefore, the AP may transmit the wake-up signal following the beacon within the reserved time. Since other APs may not transmit packets during the reserved time, the wake-up signal may be detected without interference. Please note that, in other embodiment, the wake-up signal could be transmitted prior to the beacon. The transmission order between the wake-up signal and beacon are not limited herein.

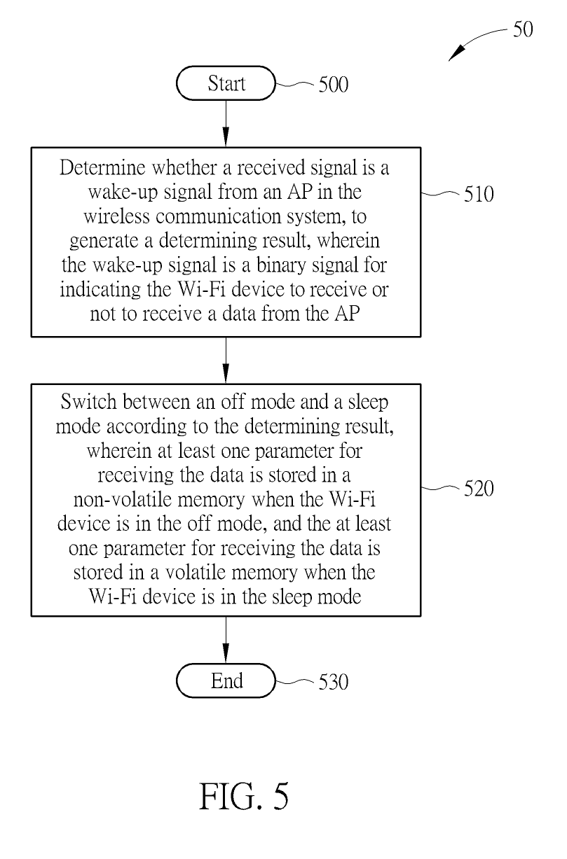

Please refer to FIG. 5, which is a flowchart of a process 50 according to an example of the present disclosure. The process 50 can be utilized in the Wi-Fi device for wake-up signal reception. The process 50 may be compiled into a program code 214 to be stored in the storage unit 210, and may include the following steps:

### Step 500: Start.

Step 510: Determine whether a received signal is a wake-up signal from an AP in the wireless communication system, to generate a determining result, wherein the wake-up signal is a binary signal for indicating the Wi-Fi device to receive or not to receive a data from the AP.
Step 520: Switch between an off mode and a sleep mode according to the determining result, wherein at least one parameter for receiving the data is stored in a non-volatile memory when the Wi-Fi device is in the off mode, and the at least one parameter for receiving the data is stored in a volatile memory when the Wi-Fi device is in the sleep mode.

### Step 530: End.

In one embodiment, the Wi-Fi device may determine whether the received signal is a wake-up signal based on the abovementioned predefined pattern or the predefined number of bits within a predefined interval. If a number of bits or pattern of the received binary signal is conformed to the predefined number or pattern, the Wi-Fi device may determine the received signal is a wake-up signal, and may switch from the off mode to the sleep mode. On the other hand, if the number of bits or pattern of the received binary signal is not conformed to the predefined number or pattern, the Wi-Fi device may determine the received signal is not a wake-up signal, and may therefore stay at the off mode for power saving.

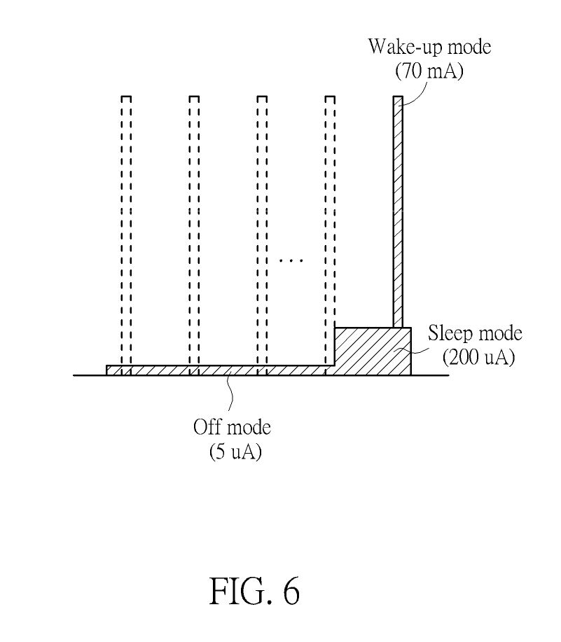

The present invention provides a new power saving mode, called off mode. At least one parameter for receiving the data (e.g. parameter(s) for setting MAC/baseband/RF components) may be stored in a non-volatile memory (e.g. ROM, flash, etc.) when the Wi-Fi device is in the off mode. While the at least one parameter for receiving the data may be stored in a volatile memory (e.g. SRAM, DRAM, etc.) when the Wi-Fi device is in the sleep mode. As a result, the Wi-Fi device in the off mode can save more power than the sleep mode since the at least one parameter for data reception can be stored in the non-volatile memory, so that power supplied to the memory can be turned off. Besides, in the off mode, the Wi-Fi device may not turn on the RF component for receiving delivery traffic indication map (DTIM), unlike the sleep mode in which the RF component may be periodically turned on for DTIM reception, so as to save more power. Refer to FIG. 6, which illustrates power consumption in different power saving modes. For example, the Wi-Fi device in the off mode may cost power around 5 uA, in the conventional sleep mode may cost power around 200 uA, and in the conventional wake-up mode, in which the RF component is continuously turned on for reception of buffered data from the AP, may cost power around 70 mA. As can be seen, compared to the sleep mode, Wi-Fi device in off mode costs less power than the conventional sleep mode, so that the battery life can be extended.

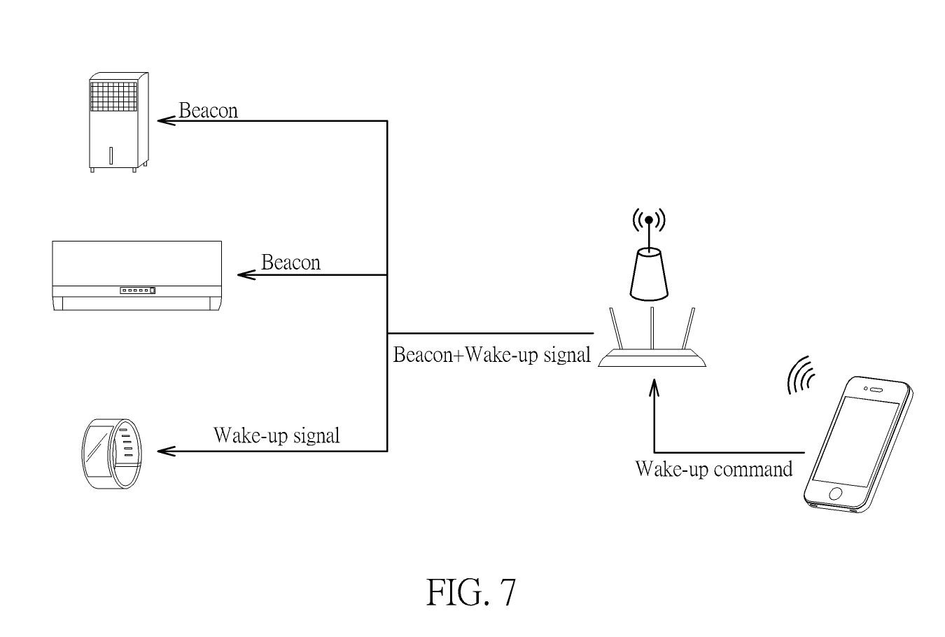

Refer to FIG. 7, which is a schematic diagram of wake-up signal transmission and reception according to an example of the present disclosure. In FIG. 7, the wake-up signal may be able to be transmitted along with the beacon from the AP to multiple Wi-Fi devices (e.g. cooler, air conditioner and wearable device) when the NAV parameter of the beacon is properly set, as shown in FIG. 4. The wearable device (e.g. eyeglasses or watch) may receive the binary wake-up signal by an ultra-low power receiver to decode the transmission. In an embodiment, the ultra-low power receiver may include the following components: an envelope detector capable of removing the carrier frequency (e.g. 2.4 GHz carrier frequency), a peak finder capable of storing the peak energy value of the Wi-Fi signals in its capacitor, a set-threshold circuit capable of halving the threshold values, and a comparator capable of outputting a “1” bit when the received energy is greater than the threshold value and a “0” bit otherwise. As a result, the decoded bit string corresponding to the wake-up signal can be used as a wake-up event. In this embodiment, the wake-up signal is detected by the ultra-low power receiver rather than high power RF component(s), so as to realize power saving in the off mode.

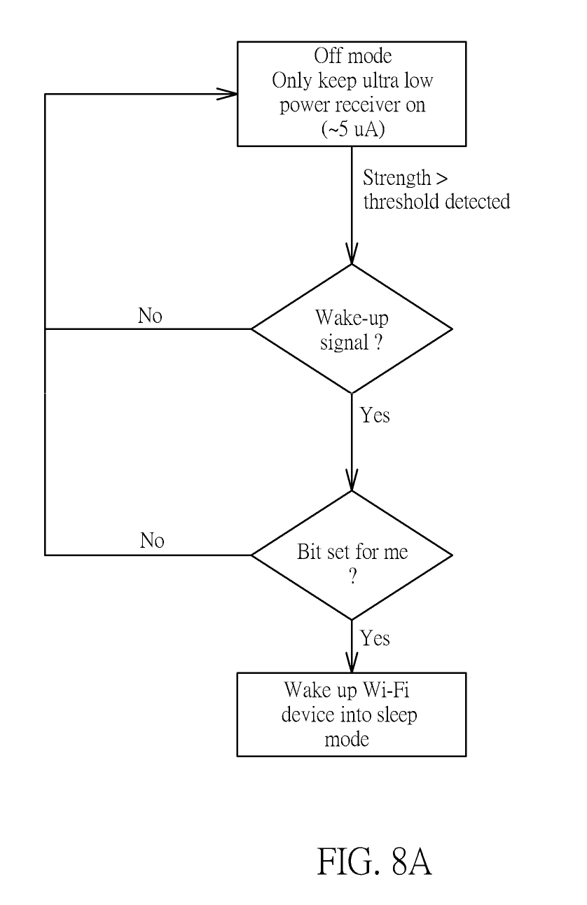

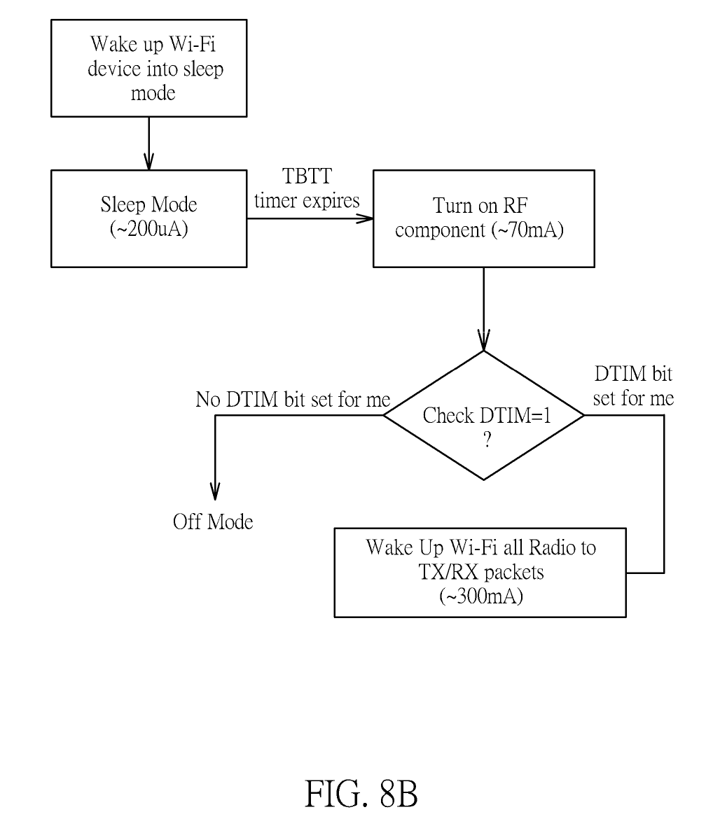

In addition, the Wi-Fi device may adopt two-level wake-up from an ultra-low power mode (i.e. the off mode). Refer to FIGS. 8A-8B, which are two-level wake-up operation according to an example of the present disclosure. In the first level, the Wi-Fi device in the off mode may only turn the ultra-low power receiver on for receiving the wake-up signal from the AP. The Wi-Fi device may detect a signal and determine whether the strength of the signal is greater than a threshold. If the strength of the received signal is greater than the threshold, the Wi-Fi device may determine whether the received signal is a wake-up signal based on a predefined number of bits within a predefined interval or a predefined pattern. If the received signal is not a wake-up signal, the Wi-Fi device may stay at the off mode. On the other hand, if the received signal is a wake-up signal, the Wi-Fi device may further check the corresponding preamble bit and payload bit of the bit string. If the preamble bit and payload bit corresponding to the Wi-Fi device are both encoded to “1”, the Wi-Fi device may therefore be waked by the AP to switch from the off mode (e.g. power consumption around 5 uA) to the sleep mode (e.g. power consumption around 200 uA). Otherwise, the Wi-Fi device may stay at the off mode to detect the wake-up signal. The Wi-Fi device may detect the wake-up signal continuously, periodically, by random intervals, or in any other way.

In the second level, when the Wi-Fi device enters the sleep mode, the Wi-Fi device may turn on a target beacon transmission time (TBTT) timer. The TBTT timer can be used for turning on the RF component for the DTIM reception. When the TBTT timer expires, the Wi-Fi device may turn the RF component(s) (e.g. receiver, amplifier, etc.) on to receive a DTIM. The DTIM may be contained in a beacon. In an embodiment, the Wi-Fi device may return to the off mode after a predetermined time or a predetermined number of that the Wi-Fi device receives no DTIM by the RF component(s). On the other hand, if the Wi-Fi receives a DTIM from the AP, the Wi-Fi device may further check if the DTIM bit is set by the AP. If the DTIM bit is set to “1”, the Wi-Fi device may therefore be switched from the sleep mode to the wake-up mode to continuously turn on the RF component (s) for receiving the buffered data from the AP. Otherwise, the Wi-Fi device may return to the off mode. Note that, wake-up signal is used for notifying the Wi-Fi device of data reception. However, the received wake-up signal may be interfered. Thus, the Wi-Fi device switched from the off mode to the sleep mode may further receive the DTIM, and check the DTIM bit for data reception confirmation.

With the ultra-low power signaling mechanism, the Wi-Fi device in the ultra-low power mode (e.g. the off mode) does not require turning the high power RF component(s) on for data reception, but utilizes a ultra-low power receiver for receiving and decoding the wake-up signal by presence/absence of Wi-Fi tone energy, so as to realize two-level wake-up.

The abovementioned steps of the processes/operations including suggested steps can be realized by means that could be a hardware, a software, or a firmware known as a combination of a hardware device and computer instructions and data that reside as read-only software on the hardware device or an electronic system. Examples of hardware can include analog, digital and mixed circuits known as microcircuit, microchip, or silicon chip. Examples of the electronic system can include a system on chip (SOC), system in package (SiP), a computer on module (COM) and the communication device 20.

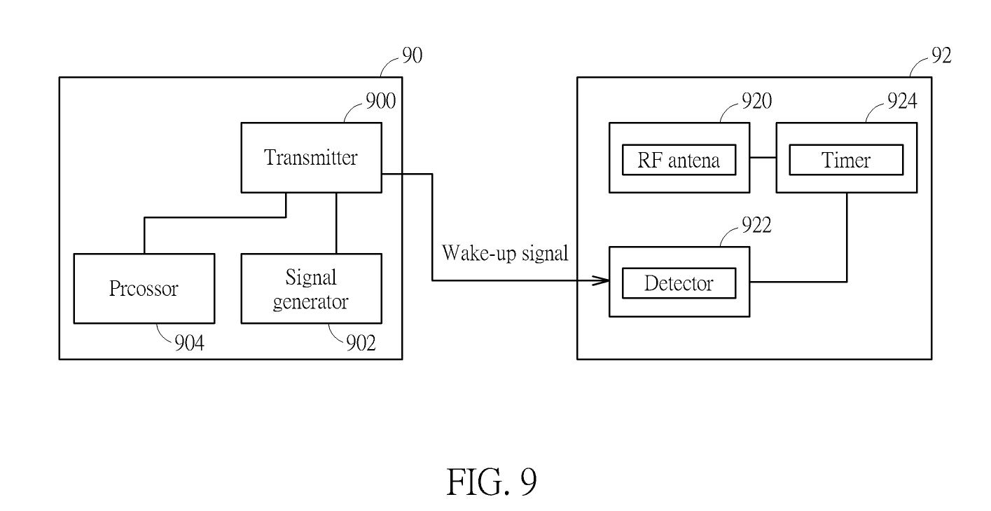

In an embodiment, refer to FIG. 9, which illustrates hardware structures of the AP and the Wi-Fi device for realizing the abovementioned processes 30 and 50 and operations shown in FIGS. 8A and 8B. In FIG. 9, the AP 90 may include at least a transmitter 900, a signal generator 902, and a processor 904. The transmitter 900 can be used for transmitting a wake-up signal to a Wi-Fi device. The transmitter 900 can also be used for transmitting a beacon for notification of the Wi-Fi device in the wireless communication system. The signal generator 902 may be coupled to the transmitter 900 and may be used for generating the wake-up signal. The wake-up signal may be a binary signal for indicating the Wi-Fi device to receive or not to receive the data from the AP. The processor 904 may be coupled to the transmitter 900. The processor 904 may be used for including a network allocation vector (NAV) parameter in the beacon to reserve time for wake-up signal transmission and for controlling the transmitter 900 to transmit the wake-up signal within the reserved time. On the other hand, the Wi-Fi device 92 may include a beacon reception module 920, an energy detecting module 922 and a power manager 924. The beacon reception module 920 may be used for determining a delivery traffic indication map (DTIM) indicating the Wi-Fi device of a buffered data or no buffered data from the AP. The DTIM may be contained in a beacon. The beacon reception module 920 may also be used for determining whether a beacon from the AP 90 is received by a RF component of the beacon reception module 920. The energy detecting module 922 may be used for determining whether a signal received by a detector of the energy detecting module 922 is a wake-up signal from the AP 90 to generate a determining result. In addition, the power manager 924 may be coupled to the energy detecting module 922 and may be used for switching the Wi-Fi device 92 between an off mode, a sleep mode and a wake-up mode according to the DTIM and/or the result made by the energy detecting module 922. At least one parameter for receiving the data may be stored in a non-volatile memory when the Wi-Fi device is in the off mode, and the at least one parameter for receiving the data may be stored in a volatile memory when the Wi-Fi device is in the sleep mode. Besides, the power manager 924 may not turn on the RF component(s) for DTIM reception when the Wi-Fi device is in the off mode and may periodically turn on the RF component(s) for DTIM reception when the Wi-Fi device is in the sleep mode. Please note that, the functionality of the energy detecting module 922 may be similar to the abovementioned ultra-low power receiver to differentiate between the presence and absence of Wi-Fi tone energy, so as to lower power consumption. The related description can be realized by referring to the above, so a detailed description is omitted herein.

According to different embodiments, the steps of the processes/operations may be performed in orders different from those shown in FIGS. 3, 5, 8A and 8B, and one or more steps can be added to or removed from the processes/operations shown in FIGS. 3, 5, 8A and 8B.

In conclusion, the Wi-Fi device in the off mode provided by the present invention can save more power than the sleep mode since the at least one parameter for data reception can be stored in the non-volatile memory, so that power supplied to the memory can be turned off. Besides, the present invention addresses to wake up the Wi-Fi devices for data reception with a wake-up signal including a wake-up bitmap, so that the Wi-Fi device does not turn on the high power RF component(s) for data reception until it is waked up by the AP. Therefore, average Wi-Fi PSM power consumption can be reduced. For example, in IOT applications, it's common to deploy a lot of Wi-Fi devices at home. The real-time notification to wake up any one of these devices while keep them standby in ultra-low power is an important topic. This invention may help these devices cost almost none of power consumption during the ultra-low power mode.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of wake-up signal transmission for an access point (AP) in a wireless communication system, the method comprising:
transmitting a beacon for notification of a Wi-Fi device in the wireless communication system; and
transmitting a wake-up signal to the Wi-Fi device, wherein the wake-up signal is a binary signal for indicating the Wi-Fi device to receive or not to receive a data from the AP.

2. The method of claim 1, further comprising:
generating the wake-up signal with a bit string corresponding to the wake-up signal in a predefined number of bits within a predefined interval or in a predefined pattern.

3. The method of claim 1, wherein transmitting the wake-up signal to the Wi-Fi device comprises:
extending a period of time for beacon transmission; and
transmitting the wake-up signal following the beacon within the period of time, to the Wi-Fi device.

4. A method of wake-up signal reception for a Wi-Fi device in a wireless communication system, the method comprising:
determining whether a received signal is a wake-up signal from an access point (AP) in the wireless communication system, to generate a determining result, wherein the wake-up signal is a binary signal for indicating the Wi-Fi device to receive or not to receive a data from the AP; and
switching between an off mode and a sleep mode according to the determining result, wherein at least one parameter for receiving the data is stored in a non-volatile memory when the Wi-Fi device is in the off mode, and the at least one parameter for receiving the data is stored in a volatile memory when the Wi-Fi device is in the sleep mode.

5. The method of claim 4, wherein determining whether the received signal is the wake-up signal from the AP in the wireless communication system comprises:
determining whether the received signal is the wake-up signal according to a bit string corresponding to the received signal in a predefined number of bits within a predefined interval or in a predefined pattern.

6. The method of claim 5, wherein determining whether the received signal is the wake-up signal according to the bit string corresponding to the received signal in the predefined number of bits within the predefined interval or in the predefined pattern comprises:
determining the received signal is the wake-up signal when a number of bits in the bit string is conformed to the predefined number of bits within the predefined interval, or when the bit string is conformed to the predefined pattern; and
determining the received signal is not the wake-up signal when the number of bits in the bit string is not conformed to the predefined number of bits within the predefined interval, or when the bit string is not conformed to the predefined pattern.

7. The method of claim 4, wherein switching between the off mode and the sleep mode according to the determining result comprises:
staying at the off mode when the determining result indicates that the received signal is not the wake-up signal;
staying at the off mode when the determining result indicates that the received signal is the wake-up signal but the wake-up signal indicates the Wi-Fi device not to receives the data; and
switching from the off mode to the sleep mode when the determining result indicates that the received signal is the wake-up signal and the wake-up signal indicates the Wi-Fi device to receive the data.

8. The method of claim 7, further comprising:
after switching from the off mode to the sleep mode, turning on a target beacon transmission time (TBTT) timer;
turning on a RF component for reception of a delivery traffic indication map (DTIM) when the TBTT timer expires; and
switching between the off mode, the sleep mode and a wake-up mode according to the DTIM, wherein the Wi-Fi device in the wake-up mode continuously turns on the RF component for reception of a buffered data from the AP.

9. The method of claim 8, further comprising:
determining the DTIM indicating the Wi-Fi device of the buffered data or no buffered data from the AP.

10. The method of claim 9, wherein switching between the off mode, the sleep mode and the wake-up mode according to the DTIM comprises:
switching from the sleep mode to the wake-up mode when the DTIM indicating the Wi-Fi device of the buffered data from the AP; and
switching from the sleep mode to the off mode when the DTIM indicating the Wi-Fi device of no buffered data from the AP.

11. An access point (AP) for wake-up signal transmission in a wireless communication system, the AP comprising:
a transmitter, for transmitting a beacon for notification of a Wi-Fi device in the wireless communication system and for transmitting a wake-up signal to the Wi-Fi device; and
a signal generator, coupled to the transmitter, for generating the wake-up signal, wherein the wake-up signal is a binary signal for indicating the Wi-Fi device to receive or not to receive a data from the AP.

12. The AP of claim 11, wherein the signal generator generates the wake-up signal with a bit string corresponding to the wake-up signal in a predefined number of bits within a predefined interval or in a predefined pattern.

13. The AP of claim 11, further comprising:
a processor, coupled to the transmitter, for including a network allocation vector (NAV) parameter in the beacon to reserve time for wake-up signal transmission;
wherein the transmitter transmits the wake-up signal following the beacon to the Wi-Fi device within the reserved time.

14. A Wi-Fi device for wake-up signal reception in a wireless communication system, the Wi-Fi device comprising:
an energy detecting module, for determining whether a signal received by a detector of the energy detecting module is a wake-up signal from an access point (AP), to generate a determining result, wherein the wake-up signal is a binary signal for indicating the Wi-Fi device to receive or not to receive a data from the AP; and
a power manager, coupled to the energy detecting module, for switching the Wi-Fi device between an off mode and a sleep mode according to the determining result, wherein at least one parameter for receiving the data is stored in a non-volatile memory of the Wi-Fi device when the Wi-Fi device is in the off mode, and the at least one parameter for receiving the data is stored in a volatile memory of the Wi-Fi device when the Wi-Fi device is in the sleep mode.

15. The Wi-Fi device of claim 14, wherein the energy detecting module determines whether the received signal is the wake-up signal according to a bit string corresponding to the received signal in a predefined number of bits within a predefined interval or in a predefined pattern.

16. The Wi-Fi device of claim 15, wherein the energy detecting module determines the received signal is the wake-up signal when a number of bits in the bit string is conformed to the predefined number of bits within the predefined interval, or when the bit string is conformed to the predefined pattern, and determines the received signal is not the wake-up signal when the number of bits in the bit string is not conformed to the predefined number of bits within the predefined interval, or when the bit string is not conformed to the predefined pattern.

17. The Wi-Fi device of claim 14, wherein power manager controls the Wi-Fi device to stay at the off mode when the determining result indicates that the received signal is not the wake-up signal, controls the Wi-Fi device to stay at the off mode when the determining result indicates that the received signal is the wake-up signal but the wake-up signal indicates the Wi-Fi device not to receives the data, and switches the Wi-Fi device from the off mode to the sleep mode when the determining result indicates that the received signal is the wake-up signal and the wake-up signal indicates the Wi-Fi device to receive the data.

18. The Wi-Fi device of claim 17, wherein the power manager turns on a target beacon transmission time (TBTT) timer after switching the Wi-Fi device from the off mode to the sleep mode, turns on a RF component for reception of a delivery traffic indication map (DTIM) when the TBTT timer expires, and switches between the off mode, the sleep mode and a wake-up mode according to the DTIM, wherein the Wi-Fi device in the wake-up mode continuously turns on the RF component for reception of a buffered data from the AP.

19. The Wi-Fi device of claim 14, further comprising:
a beacon reception module, for determining the DTIM indicating the Wi-Fi device of a buffered data or no buffered data from the AP.

20. The Wi-Fi device of claim 19, wherein the power manager switches the Wi-Fi device from the sleep mode to a wake-up mode when the DTIM indicating the Wi-Fi device of the buffered data from the AP, and switches the Wi-Fi device from the sleep mode to the off mode when the DTIM indicating the Wi-Fi device of no buffered data from the AP.
